(19) United States
(12) Patent Application Publication
(10) Pub. No.: US 2026/0278272 A1
(43) Pub. Date: Sep. 17, 2026

(54) Document Analysis System

(71) Applicant: SoftBank Group Corp., Tokyo (JP)

(72) Inventor: Fumiko URUMA, Tokyo (JP)

(21) Appl. No.: 19/561,520

(22) Filed: Mar. 10, 2026

Related U.S. Application Data
(60) Provisional application No. 63/769,784, filed on Mar. 11, 2025.

(51) Int. Cl. G06F 40/253; G06F 40/18; G06F 40/186

(52) U.S. Cl. CPC G06F 40/253; G06F 40/18; G06F 40/186

(57) ABSTRACT

A document analysis unit analyzes grammatical errors in a document using a generative AI, and a deficiency extraction unit lists deficiency words. An automatic recording unit automatically inputs the deficiency information into electronic spreadsheet software using RPA technology, and a user interface unit presents correction proposals to a proofreader. A feedback unit utilizes the correction results as training data for the AI, improving the accuracy of the system.

### CROSS-REFERENCE TO RELATED APPLICATION

This application claims the benefit of priority from U.S. Provisional Patent Application No. 63/769,784, filed on Mar. 11, 2025. The entire contents of the priority application are incorporated herein by reference.

### BACKGROUND

The technology of the present disclosure relates to a system.

Japanese Unexamined Patent Publication No. 2022-180282 discloses a method, which is a persona chatbot control method performed by at least one processor, the method including a step of receiving a user utterance, a step of adding the user utterance to a prompt including an instruction sentence associated with a description regarding a character of a chatbot, a step of encoding the prompt, and a step of inputting the encoded prompt to a language model to generate a chatbot utterance responding to the user utterance.

### SUMMARY

A problem to be solved by the present disclosure is low efficiency and high cost in proofreading work. In related art proofreading work, a human operator had to visually check a document and manually identify grammatical errors and inappropriate expressions. This process was time-consuming, prone to human error, and as a result, there was a problem that work efficiency decreased and costs increased.

Furthermore, manual data entry was inefficient in recording proofreading results and was a factor that increased operator man-hours. In such a situation, speeding up proofreading work and improving accuracy were required, but there were limits with related art methods.

An object of the present disclosure is to solve these problems by combining generative AI and RPA technology to consistently automate the process from syntax analysis of a document to extraction of deficiency words, and automatic recording of the results. This realizes efficiency improvement and cost reduction in proofreading work, and allows an operator to concentrate on higher value-added work.

Furthermore, the system of the present disclosure not only automates work but also solves technical problems in data linkage between computer systems. Specifically, there is a data format mismatch between the output of generative AI performing natural language processing (unstructured data) and the input to electronic spreadsheet software (structured data). The present disclosure converts the analysis result of the generative AI into a specific intermediate data structure (e.g., JSON or XML format) interpretable by RPA, and by directly passing data via a memory space between applications, eliminates latency (delay) and input errors due to human intervention, and provides a technical improvement that optimizes computer resource consumption (CPU cycles and memory usage).

As a means for solving the problem, the present disclosure provides a system including a document analysis unit, a deficiency extraction unit, and an automatic recording unit. The document analysis unit has a function of receiving a document to be proofread as input data, analyzing each word or phrase in the document based on grammatical rules using a generative AI, and detecting grammatical errors and inappropriate expressions. This makes it possible to automate the related art proofreading work by visual inspection and reduce human errors.

The deficiency extraction unit extracts deficiency words detected by the document analysis unit as a list, and generates a list including position information of the corresponding deficiency words. This list clearly indicates the locations that a proofreader should check, and improves the efficiency of proofreading work.

The automatic recording unit has a function of automatically inputting the list of deficiency words generated by the deficiency extraction unit into electronic spreadsheet software using RPA technology. By inputting the content of the deficiency words, position information, and recommended correction proposals into appropriate cells according to a specified template and saving the electronic spreadsheet sheet, the proofreading results are recorded quickly and accurately. This makes it possible to eliminate the need for manual data entry and significantly reduce operator man-hours. In this way, efficiency improvement and cost reduction of proofreading work are realized.

### BRIEF DESCRIPTION OF DRAWINGS

FIG. 1 is a conceptual diagram illustrating an example of a configuration of a data processing system according to a first embodiment.

FIG. 2 is a conceptual diagram illustrating an example of main functions of a data processing apparatus and a smart device according to the first embodiment.

FIG. 3 is a conceptual diagram illustrating an example of a configuration of a data processing system according to a second embodiment.

FIG. 4 is a conceptual diagram illustrating an example of main functions of a data processing apparatus and smart glasses according to the second embodiment.

FIG. 5 is a conceptual diagram illustrating an example of a configuration of a data processing system according to a third embodiment.

FIG. 6 is a conceptual diagram illustrating an example of main functions of a data processing apparatus and a headset-type terminal according to the third embodiment.

FIG. 7 is a conceptual diagram illustrating an example of a configuration of a data processing system according to a fourth embodiment.

FIG. 8 is a conceptual diagram illustrating an example of main functions of a data processing apparatus and a robot according to the fourth embodiment.

FIG. 9 illustrates an emotion map on which a plurality of emotions are mapped.

FIG. 10 illustrates an emotion map on which a plurality of emotions are mapped.

FIG. 11 is a flowchart showing an example of a document analysis method.

### DETAILED DESCRIPTION

Hereinafter, an example of an embodiment of a system according to the technology of the present disclosure will be described with reference to the accompanying drawings.

First, terms used in the following description will be described.

In the following embodiments, a processor with a reference sign (hereinafter, simply referred to as a “processor”) may be one arithmetic device or may be a combination of a plurality of arithmetic devices. Also, the processor may be one type of arithmetic device or may be a combination of a plurality of types of arithmetic devices. Examples of the arithmetic device include a CPU (Central Processing Unit), a GPU (Graphics Processing Unit), a GPGPU (General-Purpose computing on Graphics Processing Units), an APU (Accelerated Processing Unit), and the like.

In the following embodiments, a RAM (Random Access Memory) with a reference sign is a memory in which information is temporarily stored, and is used as a work memory by a processor.

In the following embodiments, a storage with a reference sign is one or more non-volatile storage devices that store various programs, various parameters, and the like. Examples of the non-volatile storage device include a flash memory (SSD (Solid State Drive)), a magnetic disk (for example, a hard disk), or a magnetic tape, and the like.

In the following embodiments, a communication I/F (Interface) with a reference sign is an interface including a communication processor, an antenna, and the like. The communication I/F manages communication among a plurality of computers. An example of a communication standard applied to the communication I/F includes a wireless communication standard including 5G (5th Generation Mobile Communication System), Wi-Fi (registered trademark), or Bluetooth (registered trademark), and the like.

In the following embodiments, “A and/or B” is synonymous with “at least one of A and B”. That is, “A and/or B” means that it may be A only, B only, or a combination of A and B. Also, in the present specification, when three or more matters are expressed by being connected with “and/or”, the same concept as “A and/or B” is applied.

### First Embodiment

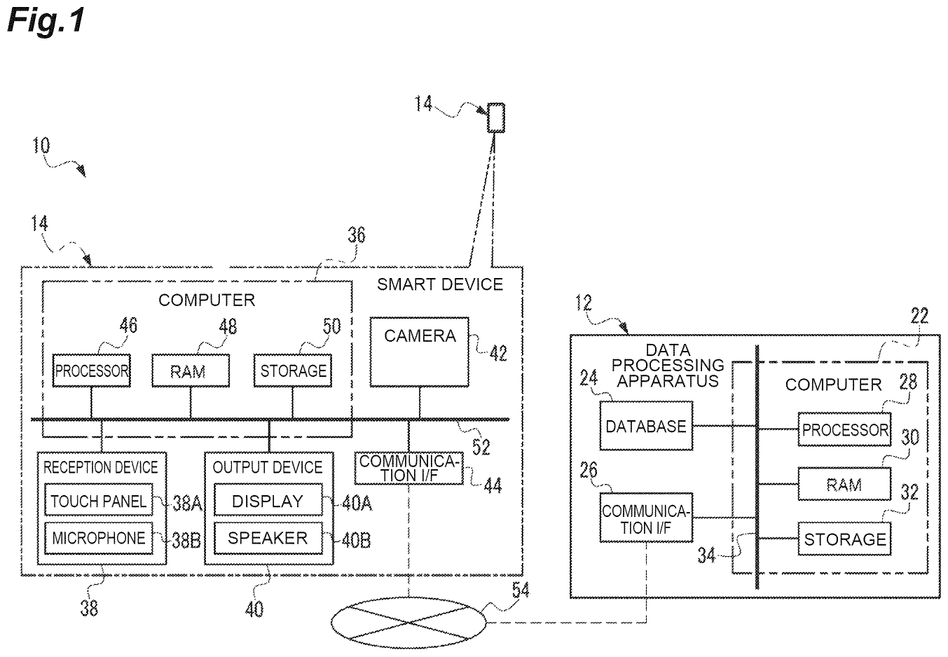

FIG. 1 illustrates an example of a configuration of a data processing system 10 according to a first embodiment.

As illustrated in FIG. 1, the data processing system 10 includes a data processing apparatus 12 and a smart device 14. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart device 14 includes a computer 36, a reception device 38, an output device 40, a camera 42, and a communication I/F 44. The computer 36 includes a processor 46, a RAM 48, and a storage 50. The processor 46, the RAM 48, and the storage 50 are connected to a bus 52. Also, the reception device 38, the output device 40, and the camera 42 are also connected to the bus 52.

The reception device 38 includes a touch panel 38A, a microphone 38B, and the like, and receives a user input. The touch panel 38A receives a user input by contact of an indicator by detecting contact of the indicator (for example, a pen or a finger, etc.). The microphone 38B receives a user input by voice by detecting a user's voice. A control unit 46A transmits data indicating the user input received by the touch panel 38A and the microphone 38B to the data processing apparatus 12. In the data processing apparatus 12, a specific processing unit 290 acquires the data indicating the user input.

The output device 40 includes a display 40A, a speaker 40B, and the like, and presents data to a user 20 by outputting the data in a representation form (for example, voice and/or text) perceivable by the user 20. The display 40A displays visible information such as text and images in accordance with an instruction from the processor 46. The speaker 40B outputs voice in accordance with an instruction from the processor 46. The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted.

The communication I/F 44 is connected to the network 54. The communication I/Fs 44 and 26 manage exchange of various information between the processor 46 and the processor 28 via the network 54.

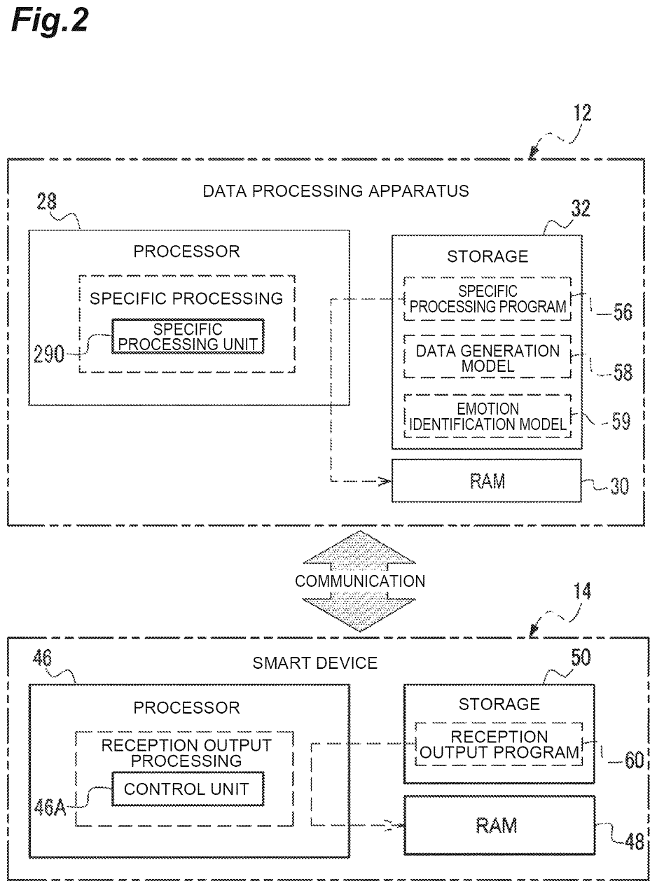

FIG. 2 illustrates an example of main functions of the data processing apparatus 12 and the smart device 14.

As illustrated in FIG. 2, in the data processing apparatus 12, specific processing is performed by the processor 28. A specific processing program 56 is stored in the storage 32. The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290. The specific processing unit 290 can estimate a user's emotion using the emotion identification model 59 and perform specific processing using the user's emotion. In an emotion estimation function (emotion identification function) using the emotion identification model 59, various estimations and predictions regarding the user's emotion, including estimation and prediction of the user's emotion, are performed, but the present disclosure is not limited to such an example. Also, the estimation and prediction of emotion include, for example, analysis (analytics) of emotion and the like.

In the smart device 14, reception output processing is performed by the processor 46. A reception output program 60 is stored in the storage 50. The reception output program 60 is used in combination with the specific processing program 56 by the data processing system 10. The processor 46 reads the reception output program 60 from the storage 50 and executes the read reception output program 60 on the RAM 48. The specific processing is realized by the processor 46 operating as a control unit 46A in accordance with the specific processing program 60 executed on the RAM 48. Note that the smart device 14 can also have a data generation model and an emotion identification model similar to the data generation model 58 and the emotion identification model 59, and perform processing similar to that of the specific processing unit 290 using these models. The reception output processing is realized by the processor 46 operating as the control unit 46A in accordance with the reception output program 60 executed on the RAM 48.

Note that an apparatus other than the data processing apparatus 12 may have the data generation model 58. For example, a server apparatus (for example, a generation server) may have the data generation model 58. In this case, the data processing apparatus 12 obtains a processing result (such as a prediction result) in which the data generation model 58 is used, by communicating with the server apparatus having the data generation model 58. Also, the data processing apparatus 12 may be a server apparatus, or may be a terminal device owned by a user (for example, a mobile phone, a robot, a home appliance, etc.). Next, an example of processing by the data processing system 10 according to the first embodiment will be described.

### Example 1

A flow of specific processing in Example 1 will be described. Each unit of the system described below is realized by the data processing apparatus 12 and the smart device 14. Also, the data processing apparatus 12 is referred to as a “server”, and the smart device 14 is referred to as a “terminal”.

### Embodiment

As an embodiment, a system configuration using a server and a terminal will be described in further detail. This system is aimed at improving the efficiency of proofreading work and includes a document analysis unit, a deficiency extraction unit, and an automatic recording unit.

First, the document analysis unit is realized on the server. The document analysis unit may be constituted by, for example, the specific processing unit 290, the specific processing program 56, the data generation model 58, and the emotion identification model 59. This unit receives a document to be proofread and analyzes each word or phrase in the document using a generative AI. By being executed on the server, it becomes possible to process a large amount of data quickly. For example, the server uses natural language processing technology to check subject-verb agreement, tense agreement, appropriate use of prepositions, punctuation positions, appropriate use of conjunctions, agreement of number and case of nouns, appropriate modification relationships of adjectives and adverbs, and the like. Thereby, grammatical errors and inappropriate expressions can be detected. Furthermore, the server can semantically analyze the content of the document and detect misuse or unnatural expressions according to the context. For example, misuse of synonyms or use of technical terms that do not fit the context are also detection targets.

The processing of the generative AI in the document analysis unit is executed at a scale and speed that are substantially impossible to perform within a human brain. Specifically, the document analysis unit tokenizes the input document and maps it to a high-dimensional vector space (e.g., thousands of dimensions or more). Then, using an attention mechanism based on a Transformer architecture, it identifies long-distance dependencies between words through parallel calculation. This processing is performed using a parallel arithmetic processor such as a GPU (Graphics Processing Unit) or TPU (Tensor Processing Unit), and is a calculation process fundamentally different from the process in which a human reads sentences sequentially.

Also, the document analysis unit may use RAG (Retrieval-Augmented Generation) technology to improve the accuracy of error detection. Specifically, past proofreading data or specific style guides are stored in a vector database, and rules related to the input document are dynamically retrieved and added to the prompt as context. Thereby, not only general-purpose grammar checks but also high-precision analysis based on domain-specific rules becomes possible.

Next, the deficiency extraction unit is also realized on the server. The deficiency extraction unit may be constituted by, for example, the specific processing unit 290, the specific processing program 56, the data generation model 58, and the emotion identification model 59. This unit extracts deficiency words detected by the document analysis unit as a list. By being executed on the server, it becomes possible to quickly aggregate analysis results and generate a list indicating locations that a proofreader should check. For example, the list of deficiency words includes position information such as line numbers and paragraph numbers in the document. Thereby, the proofreader can efficiently check the document. Also, it is possible to set priorities according to the type of deficiency so that the proofreader can check from important deficiencies in order. Furthermore, it is equipped with a function to refer to past proofreading history and alert the proofreader if similar deficiencies occur repeatedly.

Furthermore, the automatic recording unit is realized on the terminal. The automatic recording unit may be constituted by, for example, the processor 46, the reception device 38, and the output device 40. This unit automatically inputs the list of deficiency words generated by the deficiency extraction unit into electronic spreadsheet software using RPA technology. By being executed on the terminal, it becomes possible for the proofreader to check the results directly through the user interface and make corrections as necessary. For example, the RPA tool inputs the content of the deficiency words, position information, and recommended correction proposals into appropriate cells according to a designated template, and saves the electronic spreadsheet sheet. Thereby, manual data entry becomes unnecessary, and operator man-hours can be significantly reduced. Furthermore, on the terminal, a function is also provided to feed back the results of corrections of deficiencies made by the proofreader to the server in real time, which can be utilized as learning data for the AI.

The implementation of RPA technology in the automatic recording unit will be described in detail. The automatic recording unit reads the structured data (deficiency list) output by the deficiency extraction unit and identifies target cells via the DOM (Document Object Model) tree or API (Application Programming Interface) of the electronic spreadsheet software. For example, it executes a coordinate conversion algorithm that maps “line number” and “paragraph number” included in the deficiency list to “row index” and “column index” of the spreadsheet sheet. This enables faster and more stable data entry than conventional RPA that relies on image recognition on the screen.

Furthermore, after the completion of the input process, the automatic recording unit triggers a save process of the electronic spreadsheet software and writes the file to a predetermined path on the file system. This series of processes is executed as a background process of the operating system and is processed asynchronously without interfering with the user's GUI operations.

In this way, with the system configuration combining the server and the terminal, efficiency improvement and cost reduction of proofreading work can be realized. By utilizing large-scale data processing on the server and the user interface on the terminal, the proofreader can concentrate on higher value-added work. Thereby, the productivity of the entire operation improves, and the competitiveness of the enterprise can be enhanced. Also, by using a cloud-based server to increase the flexibility of the entire system, it becomes possible to proceed with work without being restricted by the location or time of performing proofreading work. Thereby, proofreading work can be performed efficiently even in a remote work environment, contributing to work style reform.

### (System Configuration)

The system according to the present embodiment includes a document analysis unit, a deficiency extraction unit, an automatic recording unit, a user interface unit, and a feedback unit. The document analysis unit has a function of receiving a document to be proofread and analyzing each word or phrase in the document using a generative AI. This unit utilizes natural language processing technology to check for subject-verb agreement, tense agreement, proper use of prepositions, punctuation position, proper use of conjunctions, agreement of noun number and case, proper modification relationships of adjectives and adverbs, and the like. For example, in a sentence such as “He go to school yesterday,” it detects a tense mismatch. Also, in a sentence such as “He played with his his friend,” it points out the redundancy of the possessive pronoun. Furthermore, in a sentence such as “He, played with his friend,” it is also possible to detect unnecessary punctuation. A specific example of a prompt sentence to be read into the generative AI could be in the format of: “Analyze the following sentence and point out any grammatical errors:”

The deficiency extraction unit has a function of extracting the deficiency words detected by the document analysis unit as a list. This unit quickly aggregates the analysis results and generates a list indicating the locations that a proofreader should check. For example, the list of deficiency words includes position information such as line numbers and paragraph numbers in the document. This allows the proofreader to efficiently check the document. It is also possible to set priorities according to the type of deficiency, so that the proofreader can check from important deficiencies in order. Furthermore, it is also provided with a function to alert the proofreader when similar deficiencies have occurred repeatedly by referring to past proofreading history.

The automatic recording unit has a function of automatically inputting the list of deficiency words generated by the deficiency extraction unit into electronic spreadsheet software using RPA technology. This unit inputs the content of the deficiency words, position information, and recommended correction proposals into appropriate cells according to a specified template, and saves the electronic spreadsheet sheet. For example, the template includes a column for describing the content of the deficiency word, a column for describing the position information in the document, and a column for describing the recommended correction proposal. This makes it possible to eliminate the need for manual data entry and significantly reduce operator man-hours. Furthermore, it is also provided with a function to feed back the results of the proofreader's corrections of deficiencies to the server in real time, which can be utilized as training data for the AI.

The user interface unit is realized on a terminal and makes it possible for a proofreader to directly check the results and make corrections as necessary. This unit provides an interface for the proofreader to visually check the list of deficiency words and to select or input correction proposals. For example, when the proofreader clicks on a deficiency word, detailed information is displayed, and options for selecting a correction proposal are presented. It is also provided with a function to immediately feed back the results to the server when the proofreader makes a correction.

The feedback unit has a function of transmitting the correction results made by the proofreader to the server and utilizing them as training data for the AI. This unit analyzes the content of the corrections made by the proofreader and accumulates them as data for improving the AI's algorithm. For example, if a proofreader consistently makes a certain correction for a specific deficiency, the AI learns that pattern and improves its ability to automatically correct similar deficiencies in the future. It is also possible to periodically evaluate the accuracy of the entire system based on the feedback data and adjust the algorithm as necessary. This allows the system to continuously evolve and contribute to the efficiency and accuracy improvement of proofreading work.

The learning process by the feedback unit includes specific technical means for reducing false positives of the system. When a proofreader rejects or changes a presented correction proposal, the feedback unit acquires the difference information and updates the model parameters of the generative AI using techniques such as fine-tuning or LoRA (Low-Rank Adaptation). Alternatively, the correction pattern is added to the vector database as “correct answer data” and referenced during the next inference. Thereby, the system adapts to a specific domain or user preference and suppresses wasteful consumption of computational resources (repetition of incorrect inferences).

### (Implementation Steps)

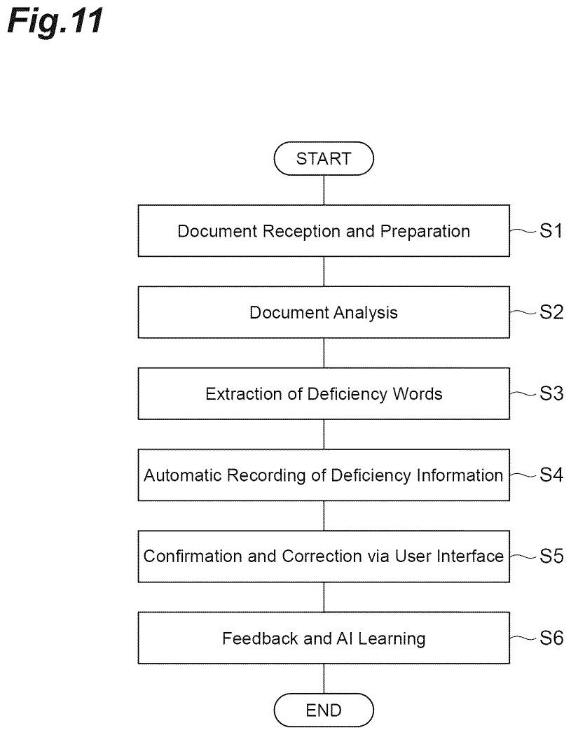

Step 1: Document Reception and Preparation (See Step S1 in FIG. 11)

A document to be proofread is received in digital format. The document is preferably in a text file or word processor file format. The received document is uploaded to a server and prepared for analysis.
Step 2: Document Analysis (See Step S2 in FIG. 11) The document analysis unit is executed on the server and analyzes each word or phrase in the document using a generative AI. It utilizes natural language processing technology to check for subject-verb agreement, tense agreement, proper use of prepositions, punctuation position, proper use of conjunctions, agreement of noun number and case, proper modification relationships of adjectives and adverbs, and the like. A specific example of a prompt sentence to be read into the generative AI could be in the format of: “Analyze the following sentence and point out any grammatical errors:”.
Step 3: Extraction of Deficiency Words (See Step S3 in FIG. 11) The deficiency extraction unit extracts the deficiency words detected by the document analysis unit as a list. It quickly aggregates the analysis results and generates a list indicating the locations that a proofreader should check. The list includes position information such as line numbers and paragraph numbers in the document. Also, it sets priorities according to the type of deficiency, so that the proofreader can check from important deficiencies in order.
Step 4: Automatic Recording of Deficiency Information (See Step S4 in FIG. 11)

The automatic recording unit automatically inputs the list of deficiency words generated by the deficiency extraction unit into electronic spreadsheet software using RPA technology. It inputs the content of the deficiency words, position information, and recommended correction proposals into appropriate cells according to a specified template, and saves the electronic spreadsheet sheet. This makes it possible to eliminate the need for manual data entry and significantly reduce operator man-hours.
Step 5: Confirmation and Correction via User Interface (See Step S5 in FIG. 11)

The user interface unit is executed on a terminal and allows a proofreader to visually check the list of deficiency words. The proofreader can use an interface for selecting or inputting correction proposals and make corrections as necessary.
Step 6: Feedback and AI Learning (See Step S6 in FIG. 11)

The feedback unit transmits the correction results made by the proofreader to the server and utilizes them as training data for the AI. It analyzes the content of the corrections made by the proofreader and accumulates them as data for improving the AI's algorithm. This allows the system to continuously evolve and contribute to the efficiency and accuracy improvement of proofreading work.

### (Specific Use Case)

For example, consider a case where the system of the present disclosure is introduced in a certain publishing industry to improve the efficiency of proofreading work. When a manuscript of a publication is uploaded to a server in digital format, the document analysis unit analyzes each word or phrase in the document using a generative AI. In this analysis, it utilizes natural language processing technology to check for subject-verb agreement, tense agreement, proper use of prepositions, punctuation position, proper use of conjunctions, agreement of noun number and case, proper modification relationships of adjectives and adverbs, and the like. A specific example of a prompt sentence to be read into the generative AI could be in the format of: “Analyze the following sentence and point out any grammatical errors:”.

The deficiency words detected by the document analysis unit are extracted as a list by the deficiency extraction unit. This list includes position information such as line numbers and paragraph numbers in the document and clearly indicates the locations that a proofreader should check. It is also possible to set priorities according to the type of deficiency, so that the proofreader can check from important deficiencies in order.

The list of deficiency words generated by the deficiency extraction unit is automatically input into electronic spreadsheet software by the automatic recording unit using RPA technology. According to a specified template, the content of the deficiency words, position information, and recommended correction proposals are input into appropriate cells, and the electronic spreadsheet sheet is saved. This eliminates the need for manual data entry and significantly reduces operator man-hours.

The user interface unit allows a proofreader to visually check the list of deficiency words and provides an interface for selecting or inputting correction proposals. When the proofreader clicks on a deficiency word, detailed information is displayed, and options for selecting a correction proposal are presented. If the proofreader makes a correction, the result is immediately fed back to the server.

The feedback unit transmits the correction results made by the proofreader to the server and utilizes them as training data for the AI. It analyzes the content of the corrections made by the proofreader and accumulates them as data for improving the AI's algorithm. This allows the system to continuously evolve and contribute to the efficiency and accuracy improvement of proofreading work. A specific example of a prompt sentence to be read into the generative AI could be in the format of: “Improve the AI's algorithm based on the following correction results:”.

In this way, the system of the present disclosure realizes efficiency improvement and cost reduction in proofreading work in the publishing industry, and allows proofreaders to concentrate on higher value-added work. This improves the productivity of the entire operation and can enhance a company's competitiveness.

### Application Example 1

A flow of specific processing in Application Example 1 will be described. Each unit of the system described below is realized by the data processing apparatus 12 and the smart device 14. Also, the data processing apparatus 12 is referred to as a “server”, and the smart device 14 is referred to as a “terminal”.

### Embodiment

As an embodiment, a system that automates content quality checking and optimization in a content distribution service will be described in further detail. This system includes a content analysis unit, a quality extraction unit, an automatic optimization unit, a user interface unit, and a feedback unit.

First, the content analysis unit receives content scheduled for distribution and analyzes grammatical errors and inappropriate expressions using a generative AI. In this analysis, it utilizes natural language processing technology to check for grammatical agreement, tense agreement, and the use of appropriate expressions. For example, it confirms subject-verb agreement in the content and detects the use of incorrect tenses. It is also possible to point out misuse of prepositions and inappropriate placement of punctuation. Furthermore, it can also propose the selection of appropriate vocabulary according to the context and the reduction of redundant expressions. A specific example of a prompt sentence to be read into the generative AI could be in the format of: “Analyze the following content and propose the optimal expression for the audience:”.

Next, the quality extraction unit evaluates the quality of the content based on the deficiencies detected by the content analysis unit and creates a list of areas that need improvement. This list includes position information within the content and specific improvement proposals. For example, it points out redundant expressions in a specific paragraph and proposes corrections to more concise expressions. It can also detect the misuse of technical terms that may hinder the audience's understanding and recommend replacement with appropriate terms. Furthermore, the quality extraction unit sets priorities based on the analysis results and lists important improvement areas in order, thereby enabling content creators to make corrections efficiently. For example, it is also possible to select expressions according to the age group or interests of the audience.

The automatic optimization unit has a function of automatically correcting and optimizing the content based on the improvement proposals generated by the quality extraction unit. This unit aims to provide high-quality content to the audience, and by taking into account feedback from the audience, it performs customization tailored to the audience's preferences. For example, based on the audience's past viewing history, it identifies preferred expression styles and adjusts the content accordingly. It is also possible to select expressions according to the age group or interests of the audience. Furthermore, it can also make immediate corrections to the content based on real-time reactions from the audience.

The user interface unit provides an interface for content creators to visually check the list of deficiencies and select or input correction proposals. For example, when a content creator clicks on a deficient part, detailed information is displayed, and options for selecting a correction proposal are presented. This allows the content creator to make corrections efficiently. Furthermore, the user interface unit is also provided with a function to record the correction history and refer to past correction contents.

The feedback unit collects reactions from the audience and utilizes them as training data for the AI. This unit analyzes the evaluations and comments made by the audience regarding the content and accumulates them as data for improving the AI's algorithm. This allows the system to continuously evolve and contribute to the quality improvement of the content distribution service. For example, if an audience gives a high evaluation to a specific expression, the AI learns to actively use that expression in future content as well. It is also possible to identify areas that need improvement based on negative feedback from the audience and utilize it for the next distribution.

In this way, the system of the present disclosure can provide a better experience to the audience and enhance the competitiveness of the service by automating the quality check and optimization of content in a content distribution service. Furthermore, to increase the flexibility of the entire system, by using a cloud-based server, it becomes possible for content creators to proceed with work without being restricted by place or time. This makes it possible to efficiently improve content quality even in a remote work environment and contributes to work style reform.

### (System Configuration)

The system according to the present embodiment includes a content analysis unit, a quality extraction unit, an automatic optimization unit, a user interface unit, and a feedback unit. The content analysis unit has a function of receiving content scheduled for distribution and analyzing grammatical errors and inappropriate expressions using a generative AI. This unit utilizes natural language processing technology to check for grammatical agreement, tense agreement, and the use of appropriate expressions. For example, it confirms subject-verb agreement in the content and detects the use of incorrect tenses. It is also possible to point out misuse of prepositions and inappropriate placement of punctuation. Furthermore, it can also propose the selection of appropriate vocabulary according to the context and the reduction of redundant expressions. A specific example of a prompt sentence to be read into the generative AI could be in the format of: “Analyze the following content and propose the optimal expression for the audience:”.

The quality extraction unit has a function of evaluating the quality of the content based on the deficiencies detected by the content analysis unit and listing the parts that need improvement. This list includes position information within the content and specific improvement proposals. For example, it points out redundant expressions in a specific paragraph and proposes corrections to more concise expressions. It can also detect the misuse of technical terms that may hinder the audience's understanding and recommend replacement with appropriate terms. Furthermore, the quality extraction unit sets priorities based on the analysis results and lists important improvement areas in order, thereby enabling content creators to make corrections efficiently. For example, it is also possible to select expressions according to the age group or interests of the audience.

The automatic optimization unit has a function of automatically correcting and optimizing the content based on the improvement proposals generated by the quality extraction unit. This unit aims to provide high-quality content to the audience, and by taking into account feedback from the audience, it performs customization tailored to the audience's preferences. For example, based on the audience's past viewing history, it identifies preferred expression styles and adjusts the content accordingly. It is also possible to select expressions according to the age group or interests of the audience. Furthermore, it can also make immediate corrections to the content based on real-time reactions from the audience.

The user interface unit provides an interface for content creators to visually check the list of deficiencies and select or input correction proposals. For example, when a content creator clicks on a deficient part, detailed information is displayed, and options for selecting a correction proposal are presented. This allows the content creator to make corrections efficiently. Furthermore, the user interface unit is also provided with a function to record the correction history and refer to past correction contents.

The feedback unit collects reactions from the audience and utilizes them as training data for the AI. This unit analyzes the evaluations and comments made by the audience regarding the content and accumulates them as data for improving the AI's algorithm. This allows the system to continuously evolve and contribute to the quality improvement of the content distribution service. For example, if an audience gives a high evaluation to a specific expression, the AI learns to actively use that expression in future content as well. It is also possible to identify areas that need improvement based on negative feedback from the audience and utilize it for the next distribution.

In this way, the system of the present disclosure can provide a better experience to the audience and enhance the competitiveness of the service by automating the quality check and optimization of content in a content distribution service. Furthermore, to increase the flexibility of the entire system, by using a cloud-based server, it becomes possible for content creators to proceed with work without being restricted by place or time. This makes it possible to efficiently improve content quality even in a remote work environment and contributes to work style reform.

### Implementation Steps

### Step 1: Content Reception and Preparation

Content scheduled for distribution is received in digital format. This content is preferably in a text file or multimedia format. The received content is uploaded to a server and prepared for analysis.

### Step 2: Content Analysis

The content analysis unit is executed on the server and analyzes grammatical errors and inappropriate expressions using a generative AI. It utilizes natural language processing technology to check for grammatical agreement, tense agreement, and the use of appropriate expressions. A specific example of a prompt sentence to be read into the generative AI could be in the format of: “Analyze the following content and propose the optimal expression for the audience:”.

### Step 3: Quality Extraction

The quality extraction unit evaluates the quality of the content based on the deficiencies detected by the content analysis unit and lists the parts that need improvement. The list includes position information within the content and specific improvement proposals. It sets priorities based on the analysis results and lists important improvement areas in order.

### Step 4: Automatic Optimization

The automatic optimization unit automatically corrects and optimizes the content based on the improvement proposals generated by the quality extraction unit. By taking into account feedback from the audience, it performs customization tailored to the audience's preferences. Based on the audience's past viewing history, it identifies preferred expression styles and adjusts the content accordingly.

### Step 5: Confirmation and Correction Via User Interface

The user interface unit is executed on a terminal and allows a content creator to visually check the list of deficiencies. It is possible to use an interface for selecting or inputting correction proposals and make corrections as necessary.

### Step 6: Feedback and AI Learning

The feedback unit collects reactions from the audience and utilizes them as training data for the AI. It analyzes the evaluations and comments made by the audience and accumulates them as data for improving the AI's algorithm. This allows the system to continuously evolve and contribute to the quality improvement of the content distribution service.

### (Specific Use Case)

For example, consider a case where the system of the present disclosure is used to improve the quality of lecture materials on an online education platform. When lecture materials are uploaded to the platform in digital format, the content analysis unit analyzes grammatical errors and inappropriate expressions in the materials using a generative AI. In this analysis, it utilizes natural language processing technology to check for subject-verb agreement, tense agreement, and the use of appropriate technical terms. A specific example of a prompt sentence to be read into the generative AI could be in the format of: “Analyze the following lecture materials and propose the optimal expression for the students:”.

Based on the analysis results, the quality extraction unit evaluates the quality of the materials and lists the parts that need improvement. This list includes position information within the materials and specific improvement proposals. For example, it detects the misuse of technical terms and recommends replacement with appropriate terms. It is also possible to present correction proposals for making redundant explanations more concise.

The automatic optimization unit automatically corrects and optimizes the materials based on the improvement proposals generated by the quality extraction unit. By taking into account feedback from students, it performs customization tailored to the students' level of understanding. For example, based on the students' past learning history, it identifies easy-to-understand expression styles and adjusts the materials accordingly.

The user interface unit provides an interface for instructors to visually check the list of deficiencies and select or input correction proposals. When an instructor clicks on a deficient part, detailed information is displayed, and options for selecting a correction proposal are presented. This allows the instructor to efficiently correct the materials.

The feedback unit collects reactions from students and utilizes them as training data for the AI. It analyzes the evaluations and comments made by students regarding the materials and accumulates them as data for improving the AI's algorithm. This allows the system to continuously evolve and contribute to the quality improvement of the online education platform. For example, if a student gives a high evaluation to a specific explanation, the AI learns to actively use that expression in future materials as well. It is also possible to identify areas that need improvement based on negative feedback from students and utilize it for the next lecture materials.

In this way, the system of the present disclosure can provide a better learning experience to students and enhance the competitiveness of the platform by automating the quality check and optimization of lecture materials on an online education platform.

The specific processing unit 290 transmits a result of the specific processing to the smart device 14. In the smart device 14, the control unit 46A causes the output device 40 to output the result of the specific processing. The microphone 38B acquires voice indicating a user input for the result of the specific processing. The control unit 46A transmits voice data indicating the user input acquired by the microphone 38B to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but the present disclosure is not limited to such examples. Also, the AI may be an AI agent. Also, when the processing of each unit described above is performed by an AI, the processing is partially or entirely performed by the AI, but the present disclosure is not limited to such an example. Also, a process implemented by an AI including a generative AI may be replaced with a rule-based process, and a rule-based process may be replaced with a process implemented by an AI including a generative AI. Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

In the above embodiment, an example form in which the specific processing is performed by the data processing apparatus 12 has been described, but the technology of the present disclosure is not limited to this, and the specific processing may be performed by the smart device 14.

### Second Embodiment

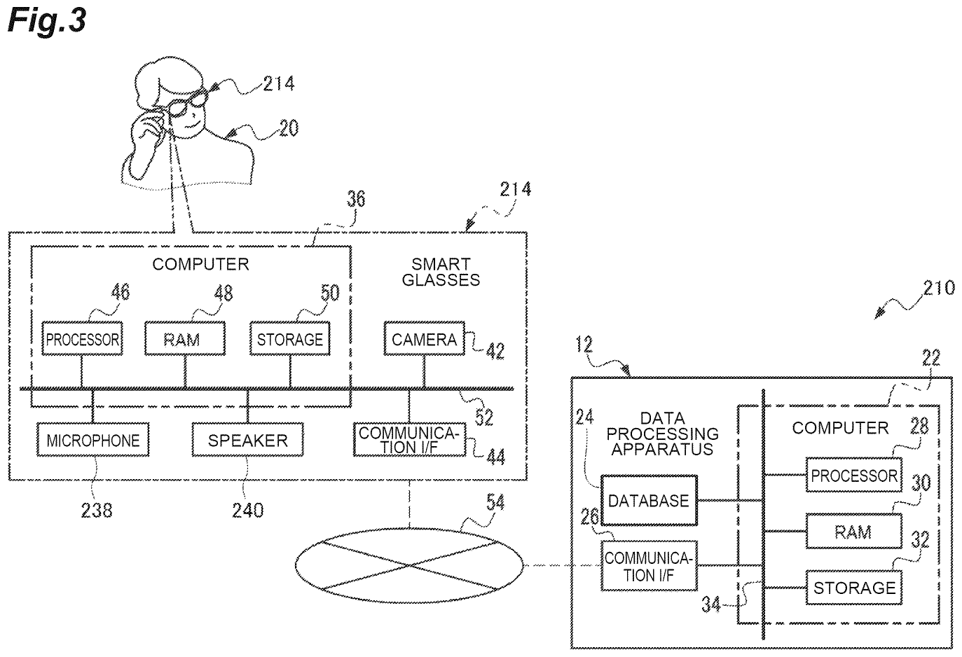

FIG. 3 illustrates an example of a configuration of a data processing system 210 according to a second embodiment.

As illustrated in FIG. 3, the data processing system 210 includes a data processing apparatus 12 and smart glasses 214. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart glasses 214 include a computer 36, a microphone 238, a speaker 240, a camera 42, and a communication I/F 44. The computer 36 includes a processor 46, a RAM 48, and a storage 50. The processor 46, the RAM 48, and the storage 50 are connected to a bus 52. Also, the microphone 238, the speaker 240, and the camera 42 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

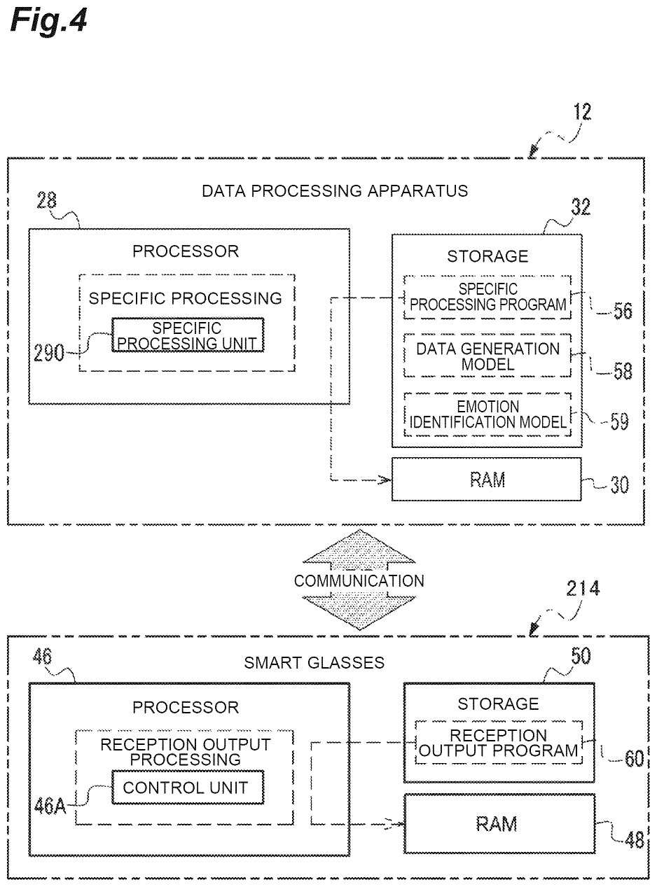

FIG. 4 illustrates an example of main functions of the data processing apparatus 12 and the smart glasses 214. As illustrated in FIG. 4, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290. The specific processing unit 290 can estimate a user's emotion using the emotion identification model 59 and perform specific processing using the user's emotion. In an emotion estimation function (emotion identification function) using the emotion identification model 59, various estimations and predictions regarding the user's emotion, including estimation and prediction of the user's emotion, are performed, but the present disclosure is not limited to such an example. Also, the estimation and prediction of emotion include, for example, analysis (analytics) of emotion and the like.

In the smart glasses 214, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48. Note that the smart glasses 214 can also have a data generation model and an emotion identification model similar to the data generation model 58 and the emotion identification model 59, and perform processing similar to that of the specific processing unit 290 using these models.

Next, specific processing by the specific processing unit 290 of the data processing apparatus 12 will be described. Each unit of the system described below is realized by the data processing apparatus 12 and the smart glasses 214. In the following description, the data processing apparatus 12 is referred to as a “server”, and the smart glasses 214 are referred to as a “terminal”.

### Example 1

Since the flow of the specific processing is the same as that in Example 1 described in the first embodiment, a description thereof is omitted.

### Application Example 1

Since the flow of the specific processing is the same as that in Example 1 described in the first embodiment, a description thereof is omitted.

The specific processing unit 290 transmits a result of the specific processing to the smart glasses 214. In the smart glasses 214, the control unit 46A causes the speaker 240 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but the present disclosure is not limited to such examples. Also, the AI may be an AI agent. Also, when the processing of each unit described above is performed by an AI, the processing is partially or entirely performed by the AI, but the present disclosure is not limited to such an example. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

In the above embodiment, an example form in which the specific processing is performed by the data processing apparatus 12 has been described, but the technology of the present disclosure is not limited to this, and the specific processing may be performed by the smart glasses 214.

### Third Embodiment

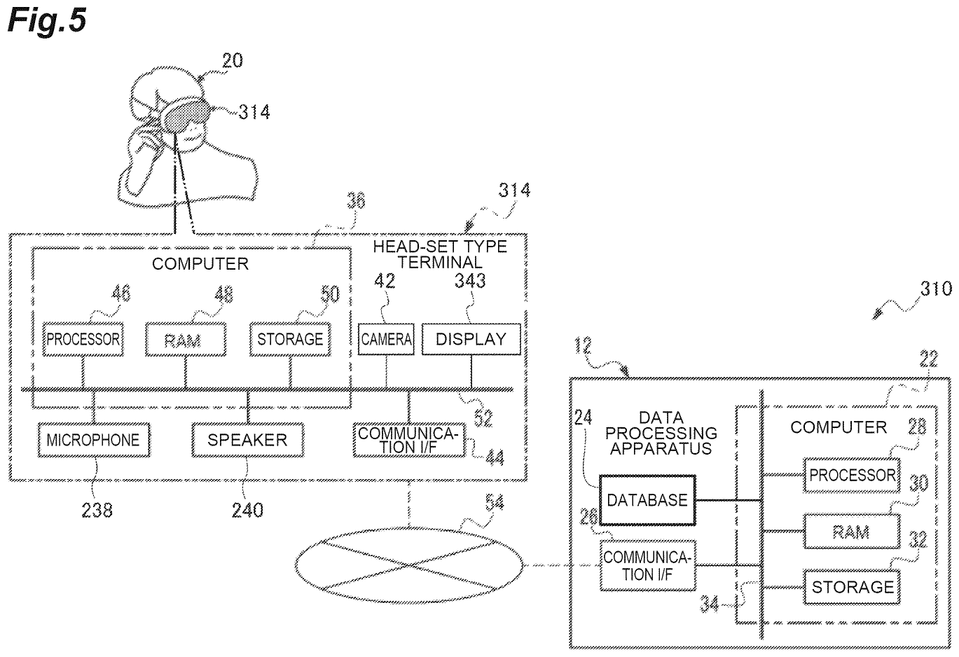

FIG. 5 illustrates an example of a configuration of a data processing system 310 according to a third embodiment.

As illustrated in FIG. 5, the data processing system 310 includes a data processing apparatus 12 and a headset-type terminal 314. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The headset-type terminal 314 includes a computer 36, a microphone 238, a speaker 240, a camera 42, a communication I/F 44, and a display 343. The computer 36 includes a processor 46, a RAM 48, and a storage 50. The processor 46, the RAM 48, and the storage 50 are connected to a bus 52. Also, the microphone 238, the speaker 240, the camera 42, and the display 343 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

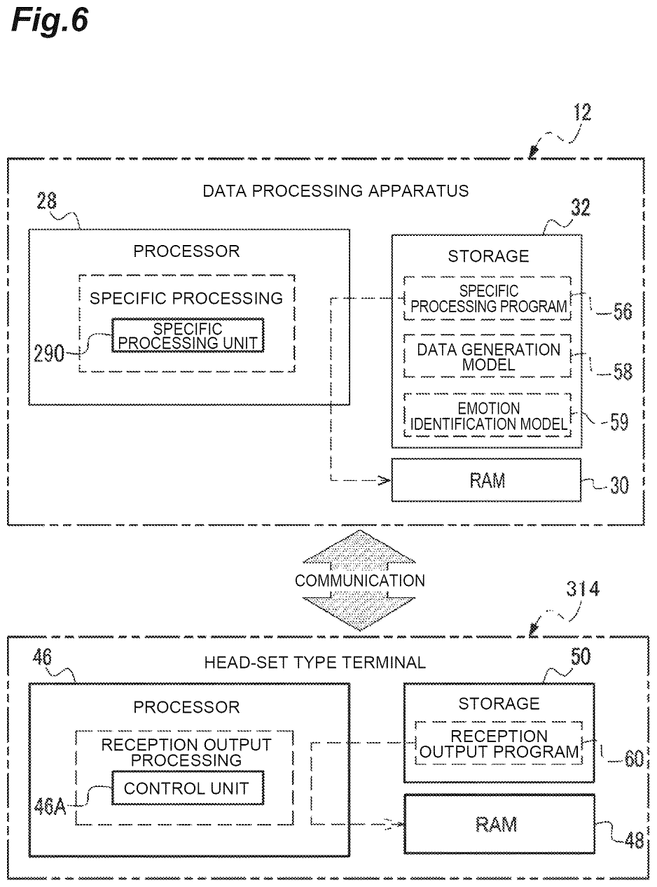

FIG. 6 illustrates an example of main functions of the data processing apparatus 12 and the headset-type terminal 314. As illustrated in FIG. 6, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290.

In the headset-type terminal 314, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48.

Next, specific processing by the specific processing unit 290 of the data processing apparatus 12 will be described. Each unit of the system described below is realized by the data processing apparatus 12 and the headset-type terminal 314. In the following description, the data processing apparatus 12 is referred to as a “server”, and the headset-type terminal 314 is referred to as a “terminal”.

### Example 1

Since the flow of the specific processing is the same as that in Example 1 described in the first embodiment, a description thereof is omitted.

### Application Example 1

Since the flow of the specific processing is the same as that in Example 1 described in the first embodiment, a description thereof is omitted.

The specific processing unit 290 transmits a result of the specific processing to the headset-type terminal 314. In the headset-type terminal 314, the control unit 46A causes the speaker 240 and the display 343 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but the present disclosure is not limited to such examples. Also, the AI may be an AI agent. Also, when the processing of each unit described above is performed by an AI, the processing is partially or entirely performed by the AI, but the present disclosure is not limited to such an example. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

In the above embodiment, an example form in which the specific processing is performed by the data processing apparatus 12 has been described, but the technology of the present disclosure is not limited to this, and the specific processing may be performed by the headset-type terminal 314.

### Fourth Embodiment

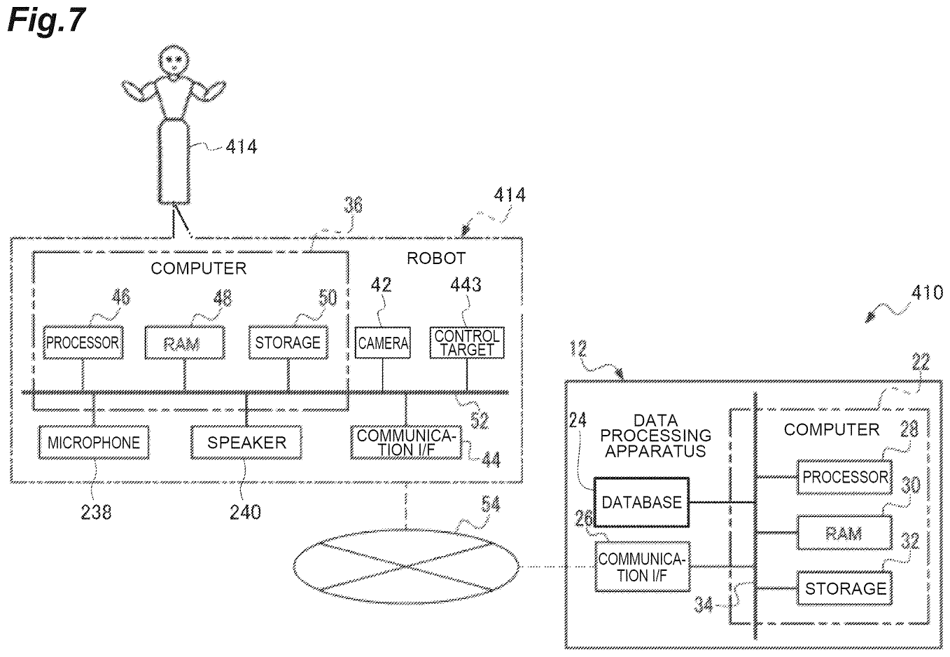

FIG. 7 illustrates an example of a configuration of a data processing system 410 according to a fourth embodiment.

As illustrated in FIG. 7, the data processing system 410 includes a data processing apparatus 12 and a robot 414. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The robot 414 includes a computer 36, a microphone 238, a speaker 240, a camera 42, a communication I/F 44, and a control target 443. The computer 36 includes a processor 46, a RAM 48, and a storage 50. The processor 46, the RAM 48, and the storage 50 are connected to a bus 52. Also, the microphone 238, the speaker 240, the camera 42, and the control target 443 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

The control target 443 includes a display device, an LED of an eye part, and motors that drive an arm, a hand, a leg, and the like. The posture and gestures of the robot 414 are controlled by controlling the motors of the arm, hand, leg, and the like. A part of the emotions of the robot 414 can be expressed by controlling these motors. Also, the facial expression of the robot 414 can also be expressed by controlling the light emission state of the LED of the eye part of the robot 414.

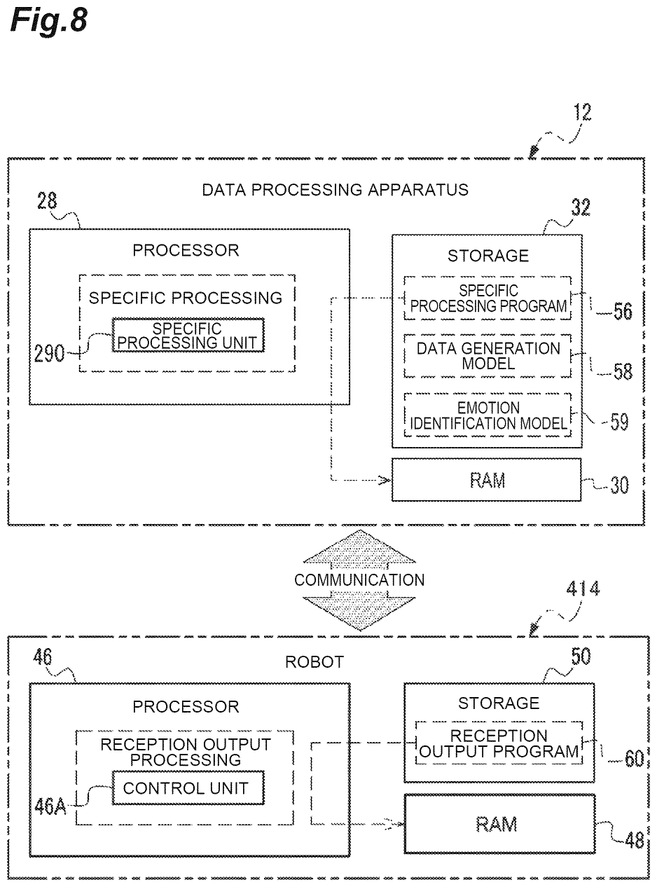

FIG. 8 illustrates an example of main functions of the data processing apparatus 12 and the robot 414. As illustrated in FIG. 8, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290.

In the robot 414, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48.

Next, specific processing by the specific processing unit 290 of the data processing apparatus 12 will be described. Each unit of the system described below is realized by the data processing apparatus 12 and the robot 414. In the following description, the data processing apparatus 12 is referred to as a “server”, and the robot 414 is referred to as a “terminal”.

### Example 1

Since the flow of the specific processing is the same as that in Example 1 described in the first embodiment, a description thereof is omitted.

### Application Example 1

Since the flow of the specific processing is the same as that in Example 1 described in the first embodiment, a description thereof is omitted.

The specific processing unit 290 transmits a result of the specific processing to the robot 414. In the robot 414, the control unit 46A causes the speaker 240 and the control target 443 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but the present disclosure is not limited to such examples. Also, the AI may be an AI agent. Also, when the processing of each unit described above is performed by an AI, the processing is partially or entirely performed by the AI, but the present disclosure is not limited to such an example. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

In the above embodiment, an example form in which the specific processing is performed by the data processing apparatus 12 has been described, but the technology of the present disclosure is not limited to this, and the specific processing may be performed by the robot 414.

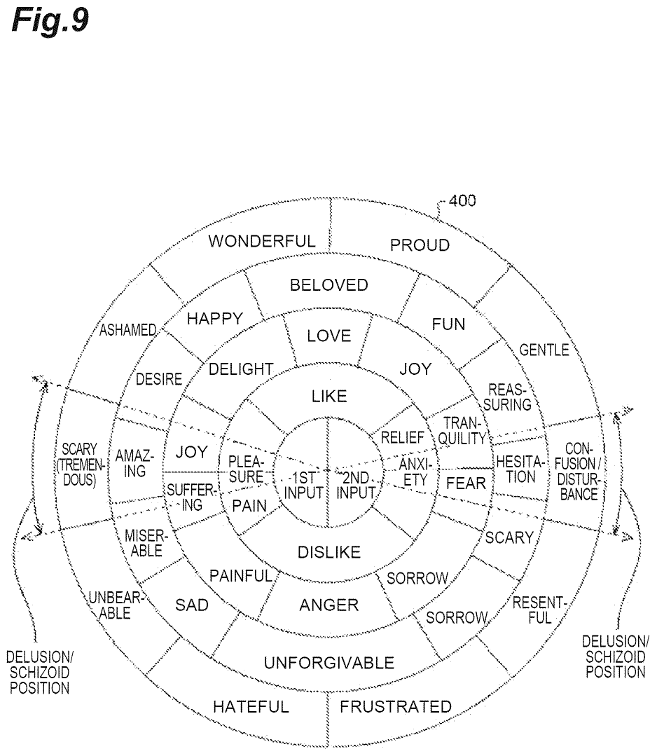

Note that the emotion identification model 59 as an emotion engine may determine a user's emotion according to a specific mapping. Specifically, the emotion identification model 59 may determine the user's emotion according to an emotion map (see FIG. 9), which is a specific mapping. Also, the emotion identification model 59 may similarly determine the robot's emotion, and the specific processing unit 290 may perform specific processing using the robot's emotion.

FIG. 9 is a diagram illustrating an emotion map 400 on which a plurality of emotions are mapped. In the emotion map 400, emotions are arranged in concentric circles radiating from the center. The closer to the center of the concentric circles, the more primitive the state of the emotion is arranged. On the outer side of the concentric circles, emotions representing states and actions arising from a state of mind are arranged. Emotion is a concept that also includes affect and mental states. On the left side of the concentric circles, emotions generated from reactions that generally occur in the brain are arranged. On the right side of the concentric circles, emotions that are generally induced by situational judgment are arranged. In the upward and downward directions of the concentric circles, emotions that are generated from reactions that generally occur in the brain and are induced by situational judgment are arranged. Also, on the upper side of the concentric circles, “pleasant” emotions are arranged, and on the lower side, “unpleasant” emotions are arranged. In this way, in the emotion map 400, a plurality of emotions are mapped based on the structure in which emotions are generated, and emotions that are likely to occur at the same time are mapped close to each other.

These emotions are distributed in the 3 o'clock direction of the emotion map 400, and usually go back and forth between relief and anxiety. In the right half of the emotion map 400, situational awareness is superior to internal sensations, resulting in a calm impression.

Since the inside of the emotion map 400 represents the inside of the mind and the outside of the emotion map 400 represents actions, the further one goes to the outside of the emotion map 400, the more visible (manifested in action) the emotion becomes.

Here, human emotions are based on various balances such as posture and blood sugar levels, and show a state of unpleasantness when those balances move away from the ideal, and a state of pleasantness when they approach the ideal. In robots, automobiles, motorcycles, and the like as well, emotions can be created based on various balances such as posture and remaining battery level, so as to show a state of unpleasantness when those balances move away from the ideal, and a state of pleasantness when they approach the ideal. The emotion map may be generated based on, for example, Dr. Mitsuyoshi's emotion map (Research on a speech emotion recognition and brain physiological signal analysis system of affect, Tokushima University, doctoral dissertation: https://ci.nii.ac.jp/naid/500000375379). In the left half of the emotion map, emotions belonging to a region called “reaction” where sensation is dominant are arranged. Also, in the right half of the emotion map, emotions belonging to a region called “situation” where situational awareness is dominant are arranged.

In the emotion map, two emotions that promote learning are defined. One is an emotion around the middle of negative “remorse” and “reflection” on the situation side. That is, it is when a negative emotion such as “I never want to feel this way again” or “I don't want to be scolded anymore” arises in the robot. The other is an emotion around positive “desire” on the reaction side. That is, it is when there is a positive feeling such as “I want more” or “I want to know more”.

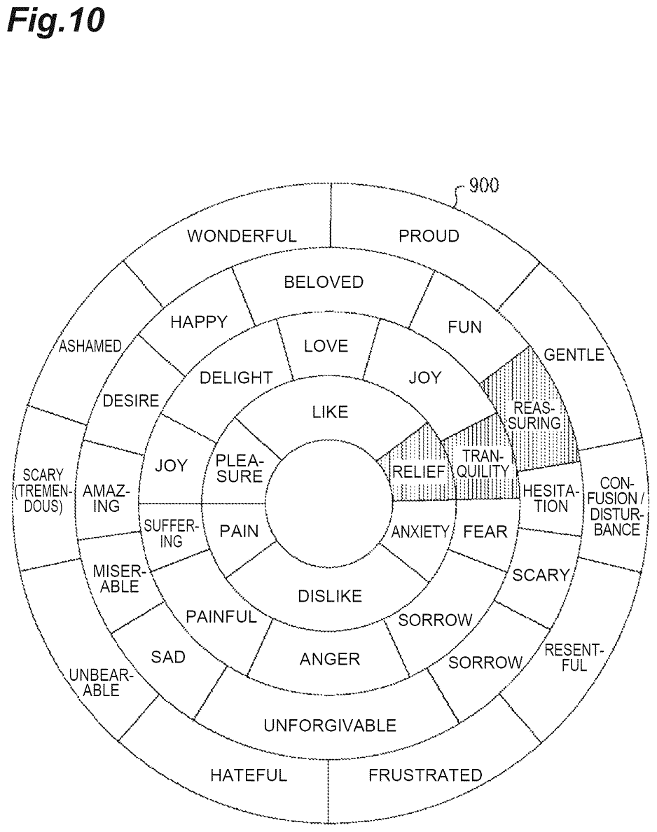

The emotion identification model 59 inputs a user input into a pre-trained neural network, acquires an emotion value indicating each emotion shown in the emotion map 400, and determines the user's emotion. This neural network is pre-trained based on a plurality of learning data that are combinations of user inputs and emotion values indicating each emotion shown in the emotion map 400. Also, this neural network is trained such that emotions arranged close to each other have close values, as in the emotion map 900 shown in FIG. 10. FIG. 10 shows an example in which a plurality of emotions, “relief,” “peace of mind,” and “reassured,” have close emotion values.

Although the system according to the present disclosure has been described above mainly with respect to the functions of the data processing apparatus 12, the system according to the present disclosure is not necessarily implemented in a server. The system according to the present disclosure may be implemented as a general information processing system. The present disclosure may be implemented as, for example, a software program that runs on a personal computer, or an application that runs on a smartphone or the like. The method according to the present disclosure may be provided to a user in a Saas (Software as a Service) format.

In the above embodiment, an example form in which the specific processing is performed by one computer 22 has been described, but the technology of the present disclosure is not limited to this, and distributed processing for the specific processing may be performed by a plurality of computers including the computer 22. For example, the data generation model 58 may be provided in an external device of the data processing apparatus 12, and the external device may generate data according to the input data.

In the above embodiment, an example form in which the specific processing program 56 is stored in the storage 32 has been described, but the technology of the present disclosure is not limited to this. For example, the specific processing program 56 may be stored in a portable computer-readable non-transitory storage medium such as a USB (Universal Serial Bus) memory. The specific processing program 56 stored in the non-transitory storage medium is installed in the computer 22 of the data processing apparatus 12. The processor 28 executes the specific processing according to the specific processing program 56.

Also, the specific processing program 56 may be stored in a storage device such as a server connected to the data processing apparatus 12 via the network 54, and the specific processing program 56 may be downloaded in response to a request from the data processing apparatus 12 and installed in the computer 22.

Note that it is not necessary to store all of the specific processing program 56 in a storage device such as a server connected to the data processing apparatus 12 via the network 54, or to store all of the specific processing program 56 in the storage 32, and a part of the specific processing program 56 may be stored.

As hardware resources for executing the specific processing, various processors shown below can be used. Examples of the processor include a CPU, which is a general-purpose processor that functions as a hardware resource for executing the specific processing by executing software, that is, a program. Also, examples of the processor include a dedicated electric circuit, which is a processor having a circuit configuration specifically designed to execute specific processing, such as an FPGA (Field-Programmable Gate Array), a PLD (programmable logic device), or an ASIC (Application Specific Integrated Circuit). A memory is built in or connected to any of the processors, and any of the processors executes the specific processing by using the memory.

The hardware resource that executes the specific processing may be configured by one of these various processors, or may be configured by a combination of two or more processors of the same type or different types (for example, a combination of a plurality of FPGAs, or a combination of a CPU and an FPGA). Also, the hardware resource that executes the specific processing may be one processor.

As an example of a configuration with one processor, first, there is a form in which one processor is configured by a combination of one or more CPUs and software, and this processor functions as a hardware resource for executing the specific processing. Second, there is a form in which a processor that realizes the functions of an entire system including a plurality of hardware resources for executing the specific processing with one IC chip, as represented by an SoC (System-on-a-chip) or the like, is used. In this way, the specific processing is realized using one or more of the various processors described above as hardware resources.

Furthermore, as a hardware structure of these various processors, more specifically, an electric circuit in which circuit elements such as semiconductor elements are combined can be used. Also, the specific processing described above is merely an example. Therefore, it goes without saying that unnecessary steps may be deleted, new steps may be added, or the processing order may be changed within a scope that does not depart from the gist.

The description and illustrations shown above are detailed descriptions of the parts related to the technology of the present disclosure, and are merely an example of the technology of the present disclosure. For example, the description regarding the above-described configuration, function, operation, and effect is a description regarding an example of the configuration, function, operation, and effect of the part related to the technology of the present disclosure. Therefore, it goes without saying that unnecessary parts may be deleted, new elements may be added, or replacements may be made to the description and illustrations shown above within a scope that does not depart from the gist of the technology of the present disclosure. Also, in order to avoid confusion and facilitate understanding of the parts related to the technology of the present disclosure, in the description and illustrations shown above, descriptions regarding common general technical knowledge and the like that do not require particular explanation for enabling the implementation of the technology of the present disclosure are omitted.

All documents, patent applications, and technical standards described in this specification are incorporated herein by reference to the same extent as if each individual document, patent application, and technical standard were specifically and individually indicated to be incorporated by reference.

Regarding the above embodiments, the following is further disclosed.

### Application Example 1

### Claim 1

A system comprising a content analysis unit, a quality extraction unit, and an automatic optimization unit. The content analysis unit has a function of receiving content scheduled for distribution and analyzing grammatical errors and inappropriate expressions using a generative AI, and checks for grammatical agreement, tense agreement, and the use of appropriate expressions by utilizing natural language processing technology. The quality extraction unit has a function of evaluating the quality of the content based on the analysis results and listing the parts that need improvement, and the list includes position information within the content and specific improvement proposals. The automatic optimization unit has a function of automatically correcting and optimizing the content based on the improvement proposals generated by the quality extraction unit, making it possible to provide high-quality content to viewers.

The system, wherein the content analysis unit detects grammatical errors and inappropriate expressions with high accuracy by using “Analyze the following content and propose the optimal expression for the audience:” as a prompt sentence to be read into the generative AI. The quality extraction unit sets priorities based on the analysis results and lists important improvement areas in order, thereby enabling content creators to make corrections efficiently.

The system, wherein the automatic optimization unit, when automatically correcting and optimizing the content based on the improvement proposals generated by the quality extraction unit, performs customization tailored to the audience's preferences by taking into account feedback from the audience. The feedback unit collects reactions from the audience and utilizes them as training data for the AI, thereby continuously improving the accuracy of the system and contributing to the quality improvement of the content distribution service.

A document analysis system, comprising circuitry, wherein the circuitry is configured to: receive a document to be proofread as input data; analyze each word and phrase in the document based on grammatical rules using a generative AI, and detect grammatical errors and inappropriate expressions as deficiency words; extract the detected deficiency words as a list, wherein the list includes position information of the deficiency words; and input the generated list of the deficiency words into electronic spreadsheet software using RPA technology, wherein, in accordance with a designated template, the circuitry is configured to input content of the deficiency words, the position information of the deficiency words, and recommended correction proposals of the deficiency words into cells of the template, and save the electronic spreadsheet sheet.

The system, wherein the circuitry is configured to: analyze the document using natural language processing technology, wherein the circuitry is configured to identify the deficiency words in the document by performing an evaluation on the document based on the grammatical rules including subject-verb agreement, tense agreement, and use of prepositions.

The system, wherein the circuitry is configured to: extract the identified deficiency words as the list, wherein the list includes a line number or a paragraph number in the document as the position information of the deficiency words.

The system, wherein the circuitry is configured to: start the electronic spreadsheet software using the RPA technology and input the deficiency words in accordance with the designated template, wherein the template includes items including the content of the deficiency words, the position information of the deficiency words, and the recommended correction proposals of the deficiency words, and wherein, in the RPA technology, the items are input into the cells of the template.

A document analysis method, comprising: receiving a document to be proofread as input data; analyzing each word and phrase in the document based on grammatical rules using a generative AI, and detect grammatical errors and inappropriate expressions as deficiency words; extracting the detected deficiency words as a list, wherein the list includes position information of the deficiency words; and inputting the generated list of the deficiency words into electronic spreadsheet software using RPA technology, wherein, in accordance with a designated template, the circuitry is configured to input content of the deficiency words, the position information of the deficiency words, and recommended correction proposals of the deficiency words into cells of the template, and save the electronic spreadsheet sheet.

1. A document analysis system,
comprising circuitry,
wherein the circuitry is configured to:
receive a document to be proofread as input data;
analyze each word and phrase in the document based on grammatical rules using a generative AI, and detect grammatical errors and inappropriate expressions as deficiency words;
extract the detected deficiency words as a list, wherein the list includes position information of the deficiency words; and
input the generated list of the deficiency words into electronic spreadsheet software using RPA technology, wherein, in accordance with a designated template, the circuitry is configured to input content of the deficiency words, the position information of the deficiency words, and recommended correction proposals of the deficiency words into cells of the template, and save the electronic spreadsheet sheet.

2. The system according to claim 1,
wherein the circuitry is configured to:
analyze the document using natural language processing technology, wherein the circuitry is configured to identify the deficiency words in the document by performing an evaluation on the document based on the grammatical rules including subject-verb agreement, tense agreement, and use of prepositions.

3. The system according to claim 2,
wherein the circuitry is configured to:
extract the identified deficiency words as the list, wherein the list includes a line number or a paragraph number in the document as the position information of the deficiency words.

4. The system according to claim 1,
wherein the circuitry is configured to:
start the electronic spreadsheet software using the RPA technology and input the deficiency words in accordance with the designated template,
wherein the template includes items including the content of the deficiency words, the position information of the deficiency words, and the recommended correction proposals of the deficiency words, and
wherein, in the RPA technology, the items are input into the cells of the template.

5. A document analysis method, comprising:
receiving a document to be proofread as input data;
analyzing each word and phrase in the document based on grammatical rules using a generative AI, and detect grammatical errors and inappropriate expressions as deficiency words;
extracting the detected deficiency words as a list, wherein the list includes position information of the deficiency words; and
inputting the generated list of the deficiency words into electronic spreadsheet software using RPA technology, wherein, in accordance with a designated template, the circuitry is configured to input content of the deficiency words, the position information of the deficiency words, and recommended correction proposals of the deficiency words into cells of the template, and save the electronic spreadsheet sheet.
